(19) United States
(12) Patent Application Publication
(10) Pub. No.: US 2015/0025931 A1
(43) Pub. Date: Jan. 22, 2015

(54) BUSINESS OPPORTUNITY FORECASTING

(71) Applicant: International Business Machines Corporation, Armonk, NY (US)

(72) Inventors: Ta-Hsin Li, Danbury, CT (US); Nan Shao, Elmsford, NY (US)

(73) Assignee: International Business Machines Corporation, Armonk, NY (US)

(21) Appl. No.: 13/945,452

(22) Filed: Jul. 18, 2013

(51) Int. Cl. G06Q 30/02; G06Q 10/06

(52) U.S. Cl. CPC G06Q 30/0202; G06Q 10/0633
USPC 705/7.27

(57) ABSTRACT

A method and apparatus to determine: (a) the likelihood and timing for a sales opportunity to become a sale based on analytical models that incorporate the history of sales stage evolution and other covariates; and (b) the expected number of sales from invisible opportunities prior to a target date. Additionally, the method and apparatus is configured to predict an expected amount of revenue and/or an amount of resources given a current sales history.

### BACKGROUND

The present disclosure relates to systems and methods of business forecasting, and more specifically, relates to a forecasting system and methodology that determines (a) the likelihood and timing for a sales opportunity to become a sale based on analytical models.

Business opportunities are often tracked by a database containing potential sales opportunities and their history of sales stage and other attributes.

Opportunity forecasting is needed to shed some light on what to be expected from the sales pipeline. It can play an important role in business decision making.

Expectations from the sales pipeline include, but are not limited to: How likely a sales opportunity will be won? When a sales opportunity will be won? How likely a sales opportunity will be won in the next quarter and the quarter that follows? What is the expected revenue from current sales pipeline in the next quarter and the quarter that follows?

The win probabilities of a current opportunity depend on many factors with varying degrees of uncertainty. Such factors include: the Historical and current sales stage (e.g., identifying, verifying, conditionally agreeing, etc.); Opportunity profile (e.g., type of services, components, value, etc.); and a Client profile (e.g., industry, sector, size, etc.), etc.

Further, there is always invisible opportunities which are opportunities that will arrive before the target date of forecasting. Thus, for example, it would be desirable to be able to determine/forecast expected revenue from invisible opportunities, e.g., by the end of next quarter.

### BRIEF SUMMARY

In one aspect, there is provided a method and apparatus to determine (a) the likelihood and timing for a sales opportunity to become a sale based on analytical models that incorporate the history of sales stage evolution and other covariates (b) the expect number of sales from invisible opportunities prior to a target date.

More generally, there is provided a method and apparatus to determine (a) the likelihood and timing of a successful outcome of a workflow based on analytical models that incorporate the history of workflow evolution (work stages) and other covariates.

In one aspect, there is provided a computer-implemented system for predicting a probability of an outcome of a workflow comprising: a storage device for storing data representing a workflow, a workflow comprising two or more work stages and one or more covariables in a time sequence signature, and each work stage having a historical probability of completion as a function of time to complete and having one or more stage states, the stage states including state outcomes of a workflow at completion; one or more programmed processor units in communication with the storage device for accessing stored data, at least one of the one or more programmed processor units configured to implement a model to: predict a probability of a completion of a workflow at a future time based on past and current work stages of the workflow, the completion probability predicting using a completion probability distribution (CPD) function; predict a probability of a workflow success at a time of completion conditional on the time to completion, and the past and current work stages and related covariables, the success probability predicting using a conditional success probability (CSP) function; and produce a predicted probabilities of success at the sequence of future times by multiplying the predicted CPD with the predicted CSP.

In a further aspect, there is provided a system for predicting an amount of expected successful outcomes for opportunities over a sequence of future time instances comprising: a storage device for storing workflows data, a workflow comprising two or more work stages and one or more covariables in a time sequence signature, and each work stage having a historical probability of completion as a function of time to complete and having one or more stage states, the stage states including state outcomes of a workflow at completion; one or more programmed processor units in communication with the storage device for accessing stored data, at least one of the one or more programmed processor units configured to implement a model to: determine using one or more time-series models, an opportunity arrivals prediction, the opportunity arrivals prediction corresponding to one or more works which arrive at a future time but before a target date of prediction and have no workflow history at the date of prediction; determine an unconditional win odds model; and predict an amount of expected successful outcomes for the future opportunities as a product of the determined unconditional win odds and the forecasted opportunity arrivals.

In a further aspect, there is provided a method for predicting a probability of an outcome of a workflow comprising: receiving at a computing device, data representing a workflow, a workflow comprising two or more work stages and one or more covariables in a time sequence signature, and each work stage having a historical probability of completion as a function of time to complete and having one or more stage states, the stage states including state outcomes of a workflow at completion; predicting, using a completion probability distribution (CPD) function, a probability of a completion of a workflow at a future time based on past and current work stages of the workflow; predicting, using a conditional success probability (CSP) function, a probability of a workflow success at a time of completion conditional on the time to completion, and the past and current work stages and related covariables; and producing a predicted probabilities of success at a sequence of future times by multiplying the predicted CPD with the predicted CSP, wherein one or more programmed processor units is configured to implement a model for the probabilities of success predicting.

In yet another aspect, there is provided a method for predicting an amount of expected successful outcomes for opportunities over a sequence of future time instances comprising: receiving at a computing device, data representing a workflow, a workflow comprising two or more work stages and one or more covariables in a time sequence signature, and each work stage having a historical probability of completion as a function of time to complete and having one or more stage states, the stage states including state outcomes of a workflow at completion; determining using one or more time-series models, an opportunity arrivals prediction, the opportunity arrivals prediction corresponding to one or more works which arrive at a future time but before a target date of prediction and have no workflow history at the date of prediction; determining at the computing device an unconditional win odds model; and predicting using the computing device an amount of expected successful outcomes for future opportunities as a product of the unconditional win odds and the forecasted opportunity arrivals.

A computer program product is provided for performing operations. The computer program product includes a storage medium readable by a processing circuit and storing instructions run by the processing circuit for running methods. The storage medium readable by a processing circuit is not a propagating signal. The methods are the same as listed above.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 depicts an example “signature selling method” or SSM describing steps in evolution of a business opportunity;

FIG. 2 shows a method for sales stage based business opportunity forecasting in one embodiment;

FIG. 3 shows a forecast engine receiving data used in computing win probability distribution in one embodiment;

FIG. 4 shows an example plot of data representing visible (known) business opportunities, where each line indicates the evaluation over time (e.g., in weeks) of the signature selling method steps identified for an opportunity;

FIG. 5 shows a graph of an example probability function and represents an inverse of the logit curve representing a form of the CWP;

FIG. 6A depicts a Semi-Markov Chain model 60 for the transition of sales stages status for DPD computation;

FIG. 6B depicts an Age-Dependent Markov Model 65 for DPD computation;

FIG. 7 depicts a method 70 for win arrival forecasting for invisible opportunities;

FIG. 8A generally depicts the difference between visible opportunities data 80 and invisible opportunities data 85;

FIG. 8B shows the use of historical opportunity arrivals (time series) 90 to project the future arrival times 95 of invisible opportunities (projected arrivals);

FIG. 9 illustrates an exemplary hardware configuration of a computing system infrastructure 200 in which the present methods are run.

### DETAILED DESCRIPTION

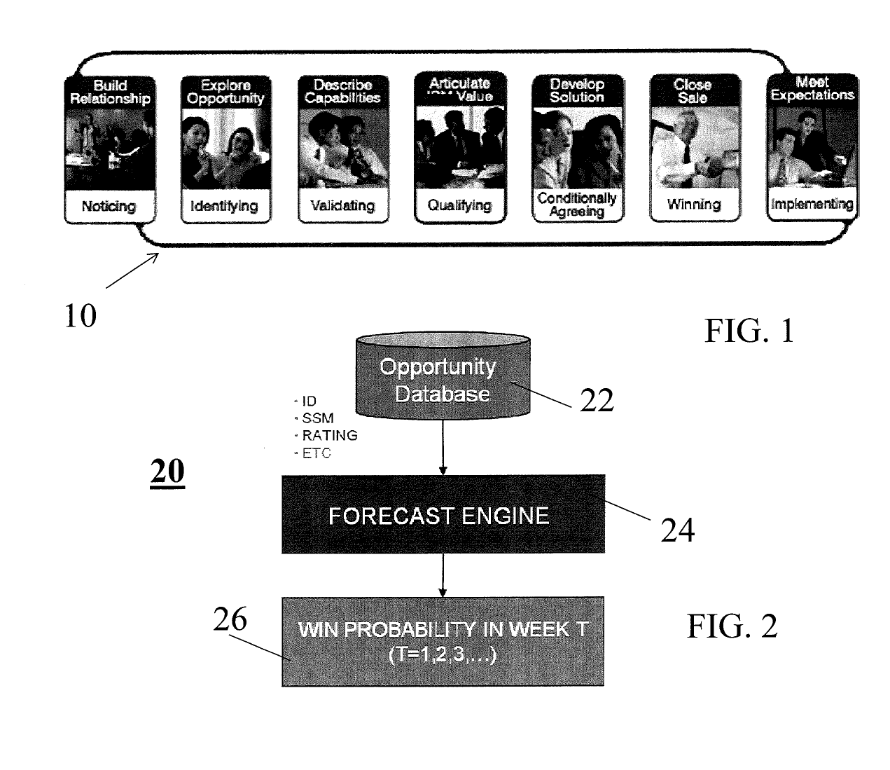

For exemplary purposes, as shown in FIG. 1, a “signature selling method” or SSM describes steps 10 in evolution of a business opportunity, e.g., for making a sale of a product or service, including one or more steps of: noticing (building relationships); identifying (exploring opportunities); validating (describing capabilities); qualifying (articulating a value); conditionally agreeing (developing a solution); winning (closing the sale) and implementing (meeting client expectations).

While the system and method described herein is described with respect to sales stage-based forecasting having SSM steps as shown in FIG. 1, the systems and methods described and claimed herein may further be configured to forecast outcomes of a “workflow” having an evolution including a time series of work stages. For example, a workflow can be the loan application process, which needs to go through a series of procedures before reaching the final outcome (approved or rejected). A workflow can also be the process of planning a software development project for freelance software developers, which includes various stages such as defining the functionalities and requirements of the software, soliciting software developers to write the code, reviewing the submitted code (if any), and finally accepting the code or cancelling the project. Thus, terms that may be referred to herein such as for example, “win” and “loss”, might be generally referred to herein as “success” and “failure”. Likewise, for example, the term referred to as “decision probability” may be generally referred to herein as “completion probability”. Likewise, for example, the term referred to as “time to decision” may otherwise be interchangeably referred to herein as “time to completion”, etc.

In an illustrative embodiment, a system 20 including a programmed computer implementing method for business opportunity forecasting (e.g., sales stage based) or Win Probability Forecasting (WPD) is shown in FIG. 2. In the system 20 of FIG. 2, there is provided a database or like memory storage unit 22 for storing the relevant sales stage based opportunity data. Such data may comprise but is not limited to, the historically relevant SSM data and associated ratings for each SSM step of a particular business opportunity. Such relevant data is accessed by and/or input to a programmed forecasting engine 24.

The system 20 including a forecasting engine 24, i.e., a processor based computing machine described below, is programmed with mathematical processing capabilities to perform methods based on mathematical/statistical models that determine both win probability and timing based on historical data from a large population of similar opportunities as well as a sales representative's estimation (rating).

In one embodiment, the forecasting engine 24 is programmed to make use of the sales stage, both current and historical, along with other attributes to output (such as via a printed or electronic display device) a forecast the win probabilities of current opportunities over a sequence of hypothetical decision dates.

Besides implementing methods for business opportunity forecasting including win (success) probability forecasting, other embodiments for business opportunity forecasting includes win arrival forecasting (e.g., for invisible opportunities) wherein the forecasting engine forecasts the expected wins from invisible opportunities using time-series models coupled with models of unconditional win odds.

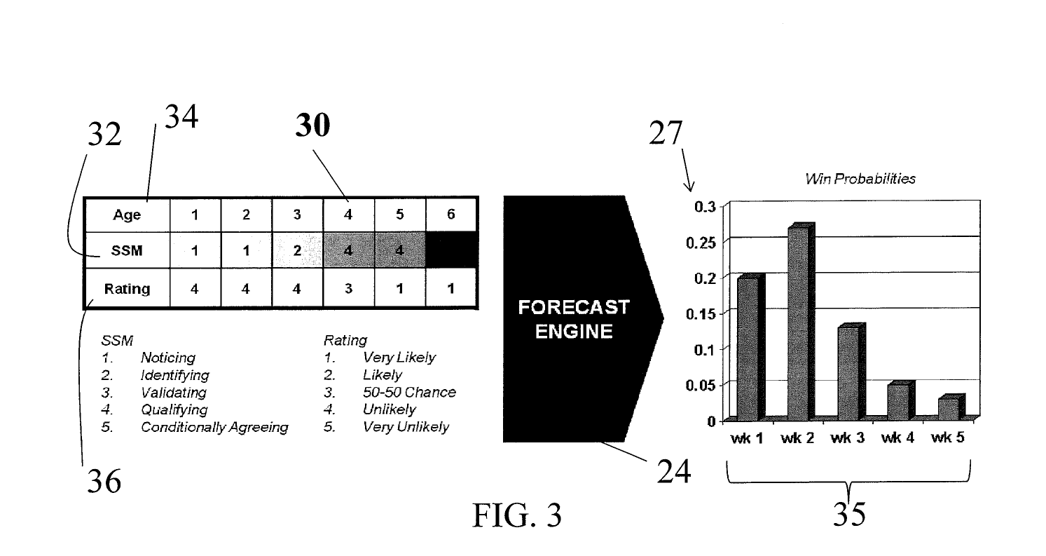

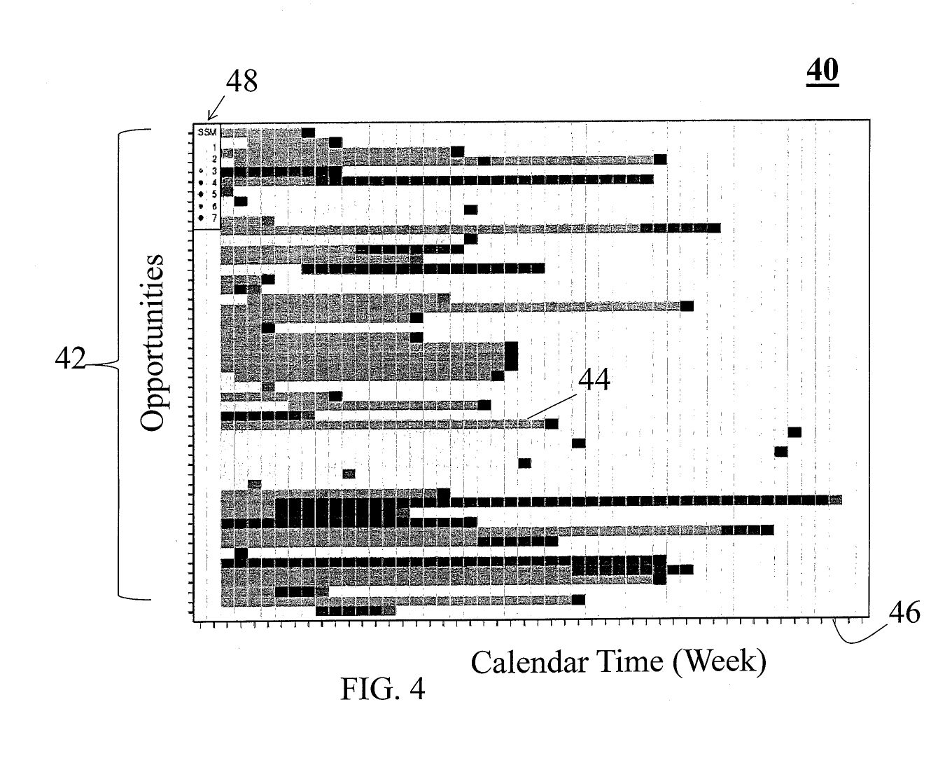

With respect to win probability forecasting, the system 20 of FIG. 2 shows a forecasting engine 24 configured for computing a probability of winning in a time to decision τ, e.g., a time interval such as a week, given the history of a sales stage and other covariates. In this embodiment, as shown in FIG. 3, the input data from the database 22 provided to the forecasting engine 20 include data such as stored in a database table 30 having values that are associated with one or more past SSMs that had subsequently resulted in a sale or not (e.g., to “completion”). Particularly, as shown in FIG. 3, responsive to processor commands, data in table 30 accessed by the processor based engine 24 include but is not limited to: for each opportunity: a mapping of the opportunity to the SSM step(s) 32, along a corresponding time line (its corresponding age) 34 indicating how old the sales stage or work stage step has been in existence, and associated covariates 36 such as an opportunity rating or status. The one or more of the SSM steps are represented in the input table 30 as example SSM steps 1)-5). The SSM rating 36 corresponding to each step may further map to and include a covariate such as a sales representative's assessment of that opportunity's win odds. These ratings are similar to SSM stages and may be updated weekly together with SSM. In an example embodiment, example ratings values range from a 1) indicating a great likelihood of the opportunity to a 5) that indicates a very unlikely chance the business opportunity will result in sale. While not limited to the rating scheme shown in FIG. 3, other status includes “likely” (a 2 rating), 50-50 chance (a 3) rating) and “unlikely” (a rating of 4). It is understood that other covariates incorporated into the model may refer to any variable used to predict the probability (e.g., time to decision, age, opportunity owner's estimate of win odds, current sales stage, value of the opportunity, sector/industry of the customer, etc.) and the database will store such client profile data and opportunity profile data.

Further, in Table 30 of FIG. 3, the age 32 represents a time unit such as weeks elapsed since the opportunity (workflow) was created. For example, in table 30, the SSM step 1) referring to the Noticing SSM step is shown as lasting for 2 weeks (a time to decision, e.g., in weeks) while its assessment value indicated by the sale's representative for example, did not change; Table 30 also depicts the SSM “qualifying” step 4) had lasted for 2 weeks (weeks 4 and 5) until its time to decision, however, its assessment value increased from a 3) to a level 1) in the 5^{th} week.

FIG. 4 shows an example plot 40 of stored evolution data representing visible (known) business opportunities 42 each plotted on the y-axis as a separate line 44 that indicates the evolution over time (e.g., in weeks) 46 of the signature selling method steps identified for an opportunity on the x-axis, and for the opportunities a code or key 48 indicating the SSM method steps (work stage steps) identified and the amount of time spent at respective SSM steps for each opportunity. This historical signature selling method (steps) data in addition to the ratings data forms the data in the database or memory storage unit table 30 of FIG. 3 stored and used by the system. From this input data, forecasting engine 24 computes an output including a probability 27 indicating a win or success of a current opportunity over a sequence 35 of one or more forecast or target decision dates, e.g., forecasted win probabilities 27 in an example future time period, e.g., the next 5 weeks, based on the SSM sale stage history and other covariates using models as programmed in the computing system.

The programmed forecasting engine implements survival models.

Survival models are based on the common assumption that the status of an opportunity does not depend on the calendar time when the opportunity was created (i.e., the time of creation). Under this assumption, the evolution of an opportunity can be represented as a function of age, i.e., the amount of time elapsed since the creation of the opportunity.

In generating the business opportunity forecasting model, notation used in the present description includes:

A: age of an opportunity

Xₐ: the current SSM stage of an opportunity at age a; XₐεX:={1, . . . , m−1,m,m+1}, with m for win and m+1 for loss (status/stage of the evolution of a business opportunity that changes)−a scalar quantity

Wₐ: the time spent in the current SSM stage at age a

Xₐ: historical evolution of the SSM stage up to age a (a-vector)

Zₐ: historical values of p covariates (any other information about opportunity, e.g., numerical/categorical) up to age a (a-by-p matrix); Example covariates include: industry sector (e.g., categorical), composition of the deal, value of the deal, etc., that maya change over time)

D: decision indicator (terminal decision), D=1 for winning (success), D=0 for losing (failure), D=2 for censoring (opportunity has no final status yet and is still ongoing)

T: lifetime of an opportunity with decision or censor time of an opportunity without decision

All these values are stored in a database, and these values may be easily derived from the stored data.

For a first goal of predicting the probabilities for an opportunity in the pipeline using a programmed computer system, such as shown in FIG. 10, there is computed in one embodiment:

p(τ|a,xₐ,zₐ):=Pr{T=a+τ,D=1|A=a,Xₐ=xₐ,Zₐ=zₐ} (τ=1,2, . . . ),

where τ is the time to decision (TTD) (forecast of a win or loss at a future target date), a=1, 2, . . . is the age, xₐ=(x₁, . . . , xₐ) is the history of SSM steps up to age a, and zₐ=(z₁, . . . , zₐ) is the history of the covariate vector up to age a. Given a, xₐ, and zₐ, the sequence p(τ|a,xₐ,zₐ) (τ=1,2, . . . ) will be referred to as the win probability distribution (WPD). In embodiments described and claimed herein below, terms that are referred to herein such as for example, WPD (win probability distribution) is alternatively referred to as a SPD (success probability distribution).

Observing that the WPD can be factored according to:

p(τ|a,xₐ,zₐ)=Pr{T=a+τ|A=a,Xₐ=xₐ,Zₐ=zₐ}×Pr{D=1|T=a+τ,A=a,Xₐ=xₐ,Zₐ=zₐ}.

The first factor will be referred to as the decision probability distribution (DPD), the second factor will be referred to as the conditional win probability (CWP). The DPD and CWP are modeled separately. In the context of a workflow, a DPD (decision probability distribution) may be alternatively referred to as a CPD (completion probability distribution); and a CWP (conditional win probability) may be alternatively referred to as a CSP (conditional success probability). The computed DPD is the probability that there is will be a decision for a particular opportunity at a target time τ, and the computed conditional win probability (CWP) is given the probability of a decision at target time τ, the probability that the outcome is a win or success.

Logistic Regression Model of the Conditional Win Probability

Assuming that the CWP has a first-order dependence between the final decision and the SSM stage history with categorical/numerical covariates:

$$Pr \{ D = 1 \vert T = a + τ , A = a , {X}_{a} = {x}_{a} , {Z}_{a} = {z}_{a} \} = Pr \{ D = 1 \vert T = a + τ , A = a , {X}_{a} = {x}_{a} , φ ( {z}_{a} ) = {c}_{a} , ψ ( {z}_{a} ) = {y}_{a} \} := g ( τ , a , {x}_{a} , {c}_{a} , {y}_{a} )$$

where xₐε{1, . . . , m−1} is the SSM stage at age a (a scalar—with no history), cₐ=φ(zₐ)ε{1, . . . , n} is a categorical mapping (e.g., rendering the value of the deal as a category, e.g., above a million dollars equals category 1, or below a million dollars equals category 2; or rendering the opportunity owner's rating of the deal), and yₐ=ψ(zₐ)εR^{q} is a numerical mapping (e.g., rendering the exact value of the deal as a number), with q being a fixed integer which does not change with a (matrix remains fixed in size and function yₐ is of fixed dimension does not increase with a; zₐ does increase with a). Under this assumption, a logistic regression (linear) model for the CWP takes the form of equation 1):

$$log it \{ g ( τ , a , {x}_{a} , {c}_{a} , {y}_{a} ) \} = {\sum }_{c = 1}^{n} \{ {δ}_{c} + {ɛ}_{c} τ + {ζ}_{c} a + {\sum }_{x = 1}^{m - 1} {η}_{cx} I ( {x}_{a} = x ) + {y}_{a}^{T} {β}_{c} \} I ( {c}_{a} = c ) , \qquad ( 1 )$$

where I(•) is the indicator function such that I(B)=1 if B is true and I(B)=0 if B is false (an adjustment that depends on current SSM status at age a). This logistic probability is a linear function of τ. Index x is the current SSM Stage and is used as an index into the database when predicting. yₐ^{T}β_{c} is the linear function of the covariants with yₐ^{T} is row vector (multiplied by vector β_{c}) results in a scalar.

In a further embodiment, additional covariates can also be incorporated into the model, e.g., covariates representing a workflow owner's assessment or predicted probability of eventual success of the work (e.g., a value between 0 and 1), or a workflow owner's assessment of a projected calendar time of completion of the work and/or projected properties of the outcome of the work (workflow) at completion (e.g., a value, a duration, and components of a contract pertaining to same) all of which may change over time with work stages may be utilized in the predicting. These can be incorporated through covariable yₐ. For example, one component of yₐ can represent the workflow owner's assessment or predicted probability of eventual success of the work or a transform of the probability (e.g., logarithmic transform), another component of yₐ can represent the time until the workflow owner's projected calendar time of completion of the work (in days) or a transform of the time, yet another component of yₐ can represent the expected value (or a transform of the value) of the deal.

The parameters {δ_{c},ε_{c},ζ_{c},η_{cx},β_{c}} in (1) are vectors estimated by a common logistic regression implemented by a programmed computer using historical records (i.e., from stored historical data) with decision status. In one embodiment, a logistic model estimation is described in Alan Agresti (Categorical Data Analysis) New York: Wiley-Interscience (2002).

{t(u)−a,a,xₐ(u),cₐ(u),yₐ(u),d(u):d(u)=0 or 1} (a=1, . . . , t(u)),

representing the historical data stored in records, where xₐ(u) is the SSM stage of the u-th opportunity at age a (where u is another index that is used to access the database when predicting), cₐ(u) is the value of the categorical covariate of the u-th opportunity at age a, yₐ(u) is the value of the numerical covariate of the u-th opportunity at age a (yₐ^{T}(u) is a transpose of vector yₐ(u)), t(u) is the life-time of the u-th opportunity, and finally, d(u) is the final status of the u-th opportunity: d(u)=1 for win, d(u)=0 for loss, and d(u)=2 for censor. t(u)−a is a time to decision of the u-th opportunity at age a.

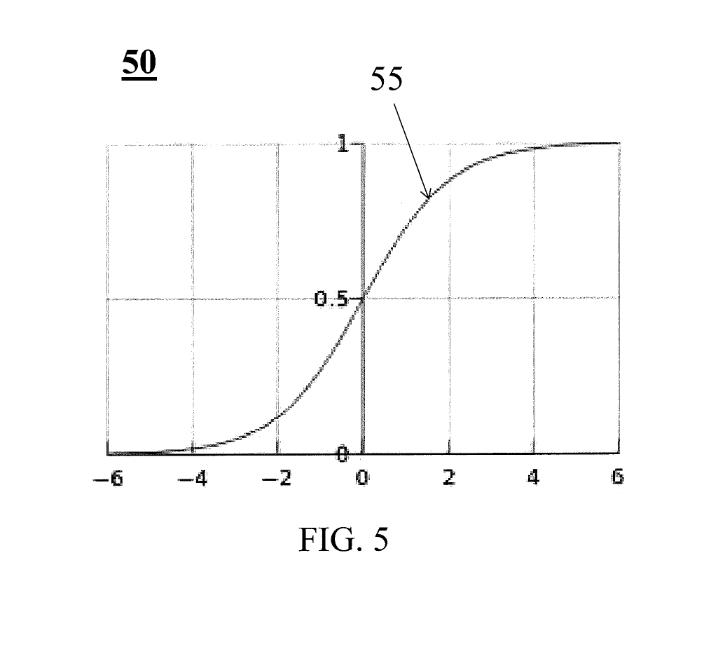

FIG. 5 shows a graph 50 of an example probability function 55 (the inverse of the logit curve) of equation 1). This sigmoid function 55 represents in the inverse logit function that coverts a value of h( . . . ) in the summation in the equation 1) on x-axis to the probability CWP(τ) on the y-axis. More particularly, from the output graph 50 there is produced a list of probabilities CWP(1), CWP(2), CWP(3), where CWP(τ)=win probability of an opportunity which will be decided in τ weeks (τ=1, 2, 3, . . . ). It is calculated using a logistic regression, i.e., the logit transform of it on the left-hand side of the equation 1) is modeled as a function h( . . . ) of the covariates. The h( . . . ) is typically a linear function of the covariates (i.e., a sum of certain coefficients times the covariates). Thus, in the forecasting of the CWP of an example opportunity there is applied a logistic function such as:

$$ln \frac{CWP}{1 - CWP} = h ( τ \& covariates )$$

As an example application, the system may forecast success of a $5 million dollar deal (opportunity) with a client in the “banking” sector (c=banking), at an example age 3 (a=3) in 2 weeks (τ=2), with the current status in stage 1 (x=1), and given the deal value (y=$5 million), these data will be input to equation 1 to obtain the sigmoid curve of FIG. 5 which is and applied to obtain the CWP. The computing steps may include: (a) receiving data representing a time to completion and current values of covariates; (b) receiving data representing parameters of the model; (c) multiplying one or more of linear and higher order terms formed by said time to completion and said covariates with said model parameters; (d) summing the products obtained from said multiplying; (e) applying a logistic function to said sum from step (d), and (f) outputting a result from said logistic function applying step (e). A general procedure for estimating the parameter of the logistic regression model from historical data is detailed in Agresti, Alan. (2002). Categorical Data Analysis. New York: Wiley-Interscience.

In a further embodiment, additional variables such as Wₐ can also be incorporated into the logistic model. It suffices to assume that the CWP takes the form:

$$Pr \{ D = 1 \vert T = a + τ , A = a , {X}_{a} = {x}_{a} , {Z}_{a} = {z}_{a} \} = Pr \{ D = 1 \vert T = a + τ , A = a , {X}_{a} = {x}_{a} , {W}_{a} = {w}_{a} , φ ( {z}_{a} ) = {c}_{a} , ψ ( {z}_{a} ) = {y}_{a} \} := g ( τ , a , {x}_{a} , {c}_{a} , {w}_{a} , {y}_{a} ) .$$

Under this assumption, a logistic regression model can be expressed according to equation 2) as:

$$log it \{ g ( τ , a , {x}_{a} , {w}_{a} , {c}_{a} , {y}_{a} ) \} = {\sum }_{c = 1}^{n} \{ {δ}_{c} + {ɛ}_{c} τ + {ζ}_{c} a + {ξ}_{c} {w}_{a} + {\sum }_{x = 1}^{m - 1} {η}_{cx} I ( {x}_{a} = x ) + {y}_{a}^{T} {β}_{c} \} I ( {c}_{a} = c ) . \qquad ( 2 )$$

This is a more general model than the model of equation (1) which does not include Wₐ information. The parameters in this model can be estimated from the data using a common logistic regression function:

{t(u)−a,a,xₐ(u),wₐ(u),cₐ(u),yₐ(u),d(u):d(u)=0 or 1} (a=1, . . . , t(u)),

where wₐ(u) is the time which the u-th opportunity with age a has spent in the stage xₐ(u).

Modeling of the Decision Probability Distribution

Geometric DPD Model

Assuming in a further embodiment that the DPD have a first-order dependence between the lifetime and the SSM stage history with categorical covariates:

$$Pr \{ T = a + τ \vert A = a , {X}_{a} = {x}_{a} , {Z}_{a} = {z}_{a} \} = Pr \{ T = a + τ \vert A = a , {X}_{a} = {x}_{a} , φ ( {z}_{a} ) = {c}_{a} \} := {h}_{1} ( τ , a , {x}_{a} , {c}_{a} ) ,$$

where xₐε{1, . . . , m−1} is the SSM stage at age a and cₐ=φ(zₐ)ε{1, . . . , n} is a categorical mapping. Under this assumption, a geometric model for the DPD as a function of 2 takes the form according to equation 3) as follows:

h₁(τ,a,xₐ,cₐ)={1−π(a,xₐ,cₐ)}π(a,xₐ,cₐ)^{τ-1} (τ=1,2, . . . ), (3)

where the parameter π(a,xₐ,cₐ) is a function depending on age, the SSM, and category and is further modeled as a log linear function:

$$log \{ π ( a , {x}_{a} , {c}_{a} ) \} = {\sum }_{c = 1}^{n} \{ {α}_{c} + {β}_{c} a + {\sum }_{x = 1}^{m - 1} {η}_{cx} I ( {x}_{a} = x ) \} I ( {c}_{a} = c ) . \qquad ( 4 )$$

It is noted that wₐ, yₐ variables are not used in this model.

It is noted that higher-order terms can also be incorporated in the regression model. For example, the quadratic term a² and/or the interaction terms a×I(xₐ=x) (x=1, . . . , m−1). The parameters {α_{c},β_{c},η_{cx}} in (4) may be estimated by the maximum likelihood method using the historical data and following life-table counts n_{L} (number of losses), n_{W} is number of wins and n_{C} number of sensored opportunities that describe how many opportunities in the pipeline that satisfy the conditions in the respective parentheses as follows:

n_{L}(τ,a,xₐ,cₐ):=#{u:t(u)=a+τ,d(u)=0,xₐ(u)=xₐ,cₐ(u)=cₐ},

n_{W}(τ,a,xₐ,cₐ):=#{u:t(u)=a+τ,d(u)=1,xₐ(u)=xₐ,cₐ(u)=cₐ},

n_{C}(τ,a,xₐ,cₐ):=#{u:t(u)=a+τ,d(u)=2,xₐ(u)=xₐ,cₐ (u)=cₐ}.

Details concerning obtaining a maximum likelihood method where geometric distribution is a special case of negative binomial distribution with a dispersion parameter equal to 1 is described in above-incorporated Agresti (2002).

The parameters {a_{c},β_{c},η_{cx}} are also estimated by a two-step approach: (1) obtain the life-table estimates of h₁(τ,a,xₐ,cₐ) (a ratio of counts) and (2) perform a log regression of the estimates on a, xₐ, and cₐ. The life-table estimate of h₁(τ,a,xₐ,cₐ), denoted as \tilde{h}₁(τ,a,xₐ,cₐ), is defined as:

$${\tilde{h}}_{1} ( τ , a , {x}_{a} , {c}_{a} ) := \frac{{n}_{D} ( τ , a , {x}_{a} , {c}_{a} )}{{n}_{R} ( a , {x}_{a} , {c}_{a} )} , where$$

$${n}_{D} ( τ , a , {x}_{a} , {c}_{a} ) := {n}_{L} ( τ , a , {x}_{a} , {c}_{a} ) + {n}_{W} ( τ , a , {x}_{a} , {c}_{a} )$$

$$and$$

$${n}_{R} ( a , {x}_{a} , {c}_{a} ) := {\sum }_{τ = 1}^{∞} \{ {n}_{D} ( τ , a , {x}_{a} , {c}_{a} ) + {n}_{C} ( τ , a , {x}_{a} , {c}_{a} ) \} .$$

It is noted that n_{D}(τ,a,xₐ,cₐ) is the number of opportunities which will be decided in τ weeks and n_{R}(a,xₐ,cₐ) is the total number of opportunities to be decided.

With the DPD and the CWP modeled by (3)-(4) and (1), respectively, the WPD (=DPD×CWP) for an opportunity of age a is given by equation 5) as follows:

p(τ|a,xₐ,zₐ)=h₁(τ,a,xₐ,cₐ)×g(τ,a,xₐ,cₐ,yₐ) (τ=1,2, . . . ) (5)

if the opportunity satisfies the conditions Xₐ=xₐ, φ(zₐ)=cₐ, and ψ(zₐ)=yₐ.

Semi-Markov Chain DPD Model

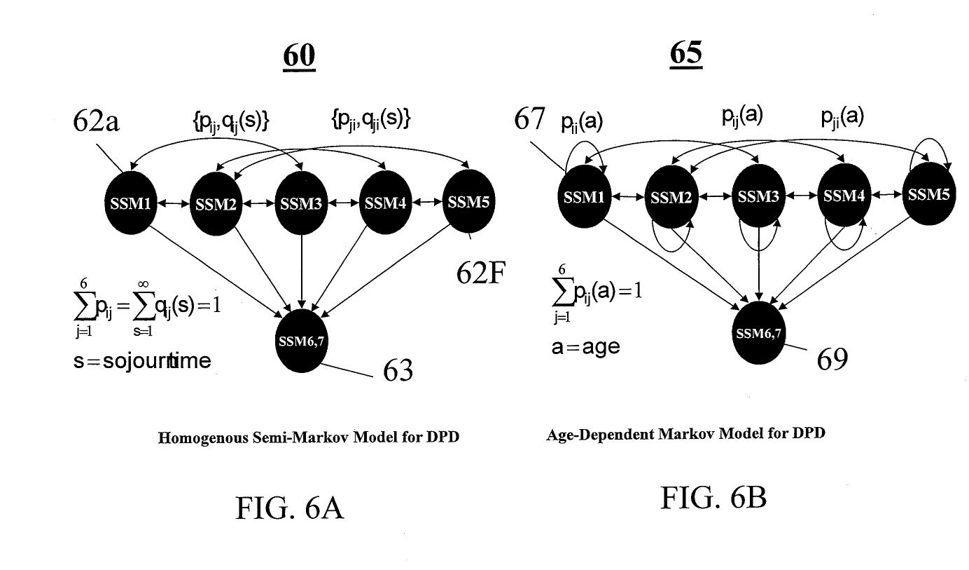

FIG. 6A depicts a homogenous Semi-Markov Model for DPD 60 including nodes 62a, . . . 62f representing either transient states and a node 63 (e.g., success/failure) representing an absorbing state. In particular FIG. 6A depicts a model 60 for the transition of sales stages status and from this model a Decision Probability Distribution (DPD) is computed. As shown in FIG. 6A there is indicated six (6) example model “states” labeled SSM1, . . . , SSM5 plus SSM6/7 (e.g., 6 states in total). Thus, the limit on the first summation is 6 because there are 6 states in this example model. Generically, the model has m states, denoted as 1, 2, . . . , m−1, m, and state m is the absorbing state. An absorbing state is a terminal state, i.e., any opportunity that enters into an absorbing state will stay in that state afterwards. It represents the combined state of “win” (success) or “loss” (failure), i.e., a decision for an opportunity. The model 60 produces list of probabilities DPD(1), DPD(2), DPD(3), etc., as a function of the time-to-decision variable τ, which takes values 1, 2, 3, etc. It is understood that transitions among states to an absorbing state 63 are represented as arrows connecting a node to other nodes, e.g., with a certain probability pᵢⱼ.

Thus, in a further embodiment, for the Semi-Markov Chain DPD Model, the forecasting engine receives current stage state of a workflow and a target cutoff time; and receives transition probabilities and sojourn-time distributions of a semi-Markov chain model having states representing the stage states of a workflow with a terminal “success” or “failure” absorption state. The system is configured to compute the probability distribution up to said target cutoff time of first time absorption of the semi-Markov chain model based on said transition probabilities and sojourn-time distributions.

Alternatively, for DPD computation, an additional “age” of a workflow and a target cutoff time could be taken into account with a received “age” variable representing a time elapsed since a start of the workflow; additionally, transition probabilities and sojourn-time distributions of an age-dependent semi-Markov chain model are received, where states of said Markov chain represent the stage states of a workflow with a terminal “success” and “failure” absorption state.

Thus as shown in FIG. 6A, this alternative DPD model can be modeled as a Semi-Markov Chain (SMC) process: DPD(τ)=Pr(first passage time from current state x to absorbing state=τ) and specifically according to:

$$Pr \{ T = a + τ \vert A = a , {X}_{a} = {x}_{a} , {Z}_{a} = {z}_{a} \} = Pr \{ T = a + τ \vert A = a , {X}_{a} = x , {W}_{a} = w \} := {h}_{2} ( τ , a , x , w ) ,$$

where w is the time spent in the current SSM stage at age a. Note that this function does not depend on the covariate Zₐ. To model this function, there is considered a homogeneous semi-Markov chain (SMC) with m states, where the SSM stages 1, . . . , m−1 are transient states and the SSM stages m (win) and m+1 (loss) together form a single absorbing state m. The following parameters define the SMC model:

pᵢ=probability that the initial state of an opportunity is in state iε1, . . . , m−1;

pᵢⱼ=conditional probability that an opportunity's next transition will be to state jε{1, . . . , m}, given that it is now in state iε{1, . . . , m−1} (transition probability);

qᵢⱼ(s)=conditional probability that an opportunity spends s weeks in state i before a transition is made to state j, given that the opportunity is in state i and will transit to state j, where s=1, 2, . . . is called the sojourn time.

These parameters are programmed to satisfy the constraints

$${p}_{ii} = 0 ( i = 1 , … , m - 1 ) , {p}_{mj} = {δ}_{m - j} ( j = 1 , … , m ) , \\ {q}_{ii} ( s ) = 0 ( i = 1 , … , m - 1 ) , {q}_{mj} ( s ) = {δ}_{s} {δ}_{m - j} ( j = 1 , … , m ) , \\ {\sum }_{j = 1}^{m} {p}_{ij} = 1 ( i = 1 , … , m ) , \\ {\sum }_{s = 1}^{∞} {q}_{ij} ( s ) = 1 ( i , j = 1 , 2 , … , m ) ,$$

where δⱼ is the delta sequence with δ₀=1 and δⱼ=0 for all j≠0. Given the model parameters {pᵢ,pᵢⱼ,qᵢⱼ(s)}, the following quantities are obtained:

$${Q}_{ij} ( s ) := {\sum }_{t = 1}^{s} {q}_{ij} ( t ) ( a sojourn time distribution ) , \\ and$$

$${r}_{ij} ( s ) := {p}_{ij} {q}_{ij} ( s ) , {r}_{i} ( s ) := {\sum }_{j = 1}^{m} {r}_{ij} ( s ) , \\ {R}_{i} ( s ) := {\sum }_{t = 1}^{s} {r}_{i} ( t ) = {\sum }_{j = 1}^{m} {p}_{ij} {Q}_{ij} ( s ) .$$

From these computed quantities, the computing system is configured to run an alternative general DPD based on the SMC model is given by equation (7) as follows:

$${h}_{2} ( τ , a , x , w ) = \frac{{r}_{xm} ( w + τ )}{1 - {R}_{x} ( w )} = \frac{{p}_{xm} {q}_{xm} ( w + τ )}{1 - {R}_{x} ( w )} . \qquad ( 7 )$$

To model the qᵢⱼ(s), assuming that the sojourn time given the origin i and the destination j has a geometric distribution:

qᵢⱼ(s)=(1−qᵢⱼ)qᵢⱼ (s=1,2, . . . ).

Under this assumption, there is obtained a sojourn time distribution:

$$\begin{matrix}{Q}_{ij} ( s ) = 1 - {q}_{ij}^{s} , 1 - {R}_{i} ( s ) \\ = {\sum }_{j = 1}^{m} {p}_{ij} ( 1 - {Q}_{ij} ( s ) ) \\ = {\sum }_{j = 1}^{m} {p}_{ij} {q}_{ij}^{s} ,\end{matrix}$$

Substituting these expressions in (7) yields

$${h}_{2} ( τ , a , x , w ) = \frac{{p}_{xm} ( 1 - {q}_{xm} )}{{\sum }_{j = 1}^{m} {p}_{xj} {q}_{xj}^{w}} {q}_{xm}^{w + τ - 1} , \qquad ( 8 )$$

Combining the DPD model (8) with the CWP model (2) the system computes the WPD of equation (9):

p(τ|a,xₐ,zₐ)=h₂(τ,a,xₐ,wₐ)×g(τ,a,xₐ,wₐ,cₐ,yₐ) (9)

for an opportunity of age a which satisfies Xₐ=xₐ, Wₐ=wₐ, φ(zₐ)=cₐ, and ψ(zₐ)=yₐ.

To estimate the parameters in the semi-Markov model, let nᵢⱼ(s) denote the number of transitions from state i to state j with sojourn time s for i=1, . . . , m−1 and j+1, . . . , m+1, where state j=m+1 is added to represents the case with censored sojourn time. Let

$${N}_{ij} ( s ) := {\sum }_{k = j}^{m + 1} {n}_{ik} ( s ) + {\sum }_{k = 1}^{m + 1} {\sum }_{t = s + 1}^{∞} {n}_{ik} ( t ) .$$

Defining

$${θ}_{ij} ( s ) := \{ \begin{matrix}1 - {n}_{ij} ( s ) / {N}_{ij} ( s ) & if {N}_{ij} ( s ) > 0 , \\ 1 & if {N}_{ij} ( s ) = 0.\end{matrix}$$

Then, according to Lagakos, Sommer, and Zelen (1978), the nonparametric maximum likelihood estimates of pᵢⱼ and Qᵢⱼ(s) are estimated from raw historical data by computing:

$$\begin{matrix}{p}_{ij} := {\sum }_{s = 1}^{∞} {p}_{ij} ( s ) , {Q}_{ij} ( s ) := {p}_{ij}^{- 1} {\sum }_{t = 1}^{s} {p}_{ij} ( t ) , & ( 10 ) \\ where & \\ {p}_{ij} ( s ) := \{ 1 - {θ}_{ij} ( s ) \} {\prod }_{k = 1}^{j - 1} {θ}_{ik} ( s ) {\prod }_{k = 1}^{m} {\prod }_{t = 1}^{s - 1} {θ}_{ik} ( t ) . & \end{matrix}$$

Because log {1−Qᵢⱼ(s)}=s×log qᵢⱼ, the parameter qᵢⱼ in the geometric model of sojourn time can be determined by performing a log regression of 1−Qᵢⱼ(s) on s.

Age-Dependent Markov Chain DPD Model

FIG. 6B depicts a further embodiment that implements an Age Dependent Markov Model 65 for DPD computation. In this embodiment, to compute the decision (completion) probability distribution for the Age-Dependent Markov Chain DPD Model, the engine receives current stage state data of a workflow and a target cutoff time, and receives transition probabilities of a Markov chain model 65 having nodes 67 represent stage states of workflows with terminal “success” or “failure” absorption states 69. Alternatively, for the model computation, an additional “age” of a workflow is received with the age representing a time elapsed since a start of the workflow; and the received transition probabilities of an age-dependent Markov chain model have states representing the stage states of a workflow with terminal “success” or “failure” absorption states.

In a further embodiment, assuming that the DPD is simplified as:

$$Pr \{ T = a + τ \vert A = a , {X}_{a} = {x}_{a} , {Z}_{a} = {z}_{a} \} = Pr \{ T = a + τ \vert A = a , {X}_{a} = x \} := {h}_{3} ( τ , a , x ) .$$

This function depends only on the current age a and the current SSM stage Xₐ and does not depend on the covariate Zₐ. Considering a Markov chain model, where the SSM stages 1, . . . , m−1 form the transient states and the combined the SSM stages m (win) and m+1 (loss) forms a single absorbing state m. Letting the transition probability from state i to stage j at age a be denoted by pᵢⱼ(a), i.e.,

pᵢⱼ(a):=Pr{Xₐ₊₁=j|A=a,Xₐ=i} (i=1, . . . , m−1; j=1, . . . , m).

In addition, there is defined the transition matrices in equation 11):

$$P ( a ) := [ \begin{matrix}{p}_{11} ( a ) & ⋯ & {p}_{1 , m - 1} ( a ) \\ ⋮ & & ⋮ \\ {p}_{m - 1 , 1} ( a ) & ⋯ & {P}_{m - 1 , m - 1} ( a )\end{matrix} ] , q ( a ) := [ \begin{matrix}{p}_{1 m} ( a ) \\ ⋮ \\ {p}_{m - 1 , m} ( a )\end{matrix} ] . \qquad ( 11 )$$

Then, the Markov chain DPD for an opportunity of age a at stage xε{1, . . . , m−1} is given by equation 12) as:

h₃(τ,x,a)=eₓ^{T}P(a)P(a+1) . . . P(a+τ−2)q(a+τ−1) (τ=1,2, . . . , τₘₐₓ), (12)

where eₓ is a vector whose x-th element equals 1 and other elements equal 0. Combining the DPD model in (11) and (12) with the CWP model in (2) the system computes the WPD of equation (13) as:

p(τ|a,xₐ,zₐ)=h₃(τ,a,xₐ)×g(τ,a,xₐ,wₐ,cₐ,yₐ) (13)

for an opportunity of age a which satisfies Xₐ=xₐ, Wₐ=wₐ, φ(zₐ)=cₐ, and ψ(zₐ)=yₐ.

Based on uncensored historical records, the computing system estimates pᵢⱼ(a) as given by:

$${p}_{ij} ( a ) = \frac{\# \{ u \text{:} {x}_{a} ( u ) = i , {x}_{a + 1} ( u ) = j , d ( u ) \neq 2 \}}{\# \{ u \text{:} {x}_{a} ( u ) = i , d ( u ) \neq 2 \}}$$

$$( i = 1 , … , m - 1 ; j = 1 , … , m ; a = 1 , 2 , … ) .$$

Kaplan-Meier DPD Model

In a further embodiment, it is assumed that the DPD is calculated using the survival curve from a Kaplan-Meier estimate. In this embodiment, for each SSM stage, instead of using the lifetime T, survival time T′ is calculated from the time when the opportunity entering the given SSM stage and category to decision or censor time, and assume that the effect of age of an opportunity on the DPD is equivalent to the effect of the time spent in the current SSM stage and category. With additional assumption of first-order dependence between the life time and the SSM stage history, DPD is computed as:

$$Pr \{ T = a + τ \vert A = a , {X}_{a} = {x}_{a} , {Z}_{a} = {z}_{a} \} = Pr ( {T}^{′} = v + τ \vert {V}_{a} = v , {X}_{a} = x , φ ( {z}_{a} ) = c \} = Pr ( {T}^{′} = v + τ \vert {T}^{′} > v , {X}_{a} = x , φ ( {z}_{a} ) = c \} := {h}_{4} ( τ , v , x , c ) ,$$

where Vₐ=v is the time spent in the current SSM stage and category at age a, x is the current SSM stage at age a, and c is the current category at age a. Letting S(t,x,c) be the survival function given current status x, i.e.,

S(t,x,c)=Pr{T′>t|A=a,Xₐ=x,φ(zₐ)=c}.

This survival function can be estimated by applying Kaplan-Meier estimation method (Kleinbaum, David G. and Klein, Mitchel (2010). Survival Analysis: A Self-learning Text. Second Edition. Springer) on data which measures the time elapsed between opportunity entering SSM stage x and category c and the decision time or censor time. Then, the Kaplan-Meier DPD model is given by equation 14) as:

h₄(τ,v,x,c)=[S(v+τ−1,x,c)−S(v+τ,x,c)]/S(v,x,c) (τ=1,2, . . . ). (14)

Combining the DPD model (14) with the CWP model (2) (with wₐ replaced by vₐ) yields the WPD of equation 15):

p(τ|a,xₐ,zₐ)=h₄(τ,vₐ,xₐ,cₐ)×g(τ,a,xₐ,vₐ,cₐ,yₐ) (15)

for an opportunity of age a which satisfies Xₐ=xₐ, Vₐ=vₐ, φ(zₐ)=cₐ, and ψ(zₐ)=yₐ.

Prediction of the Number of Wins

The system and methods are configured to predict the number of wins in week t, e.g., a future target date 5 weeks from now.

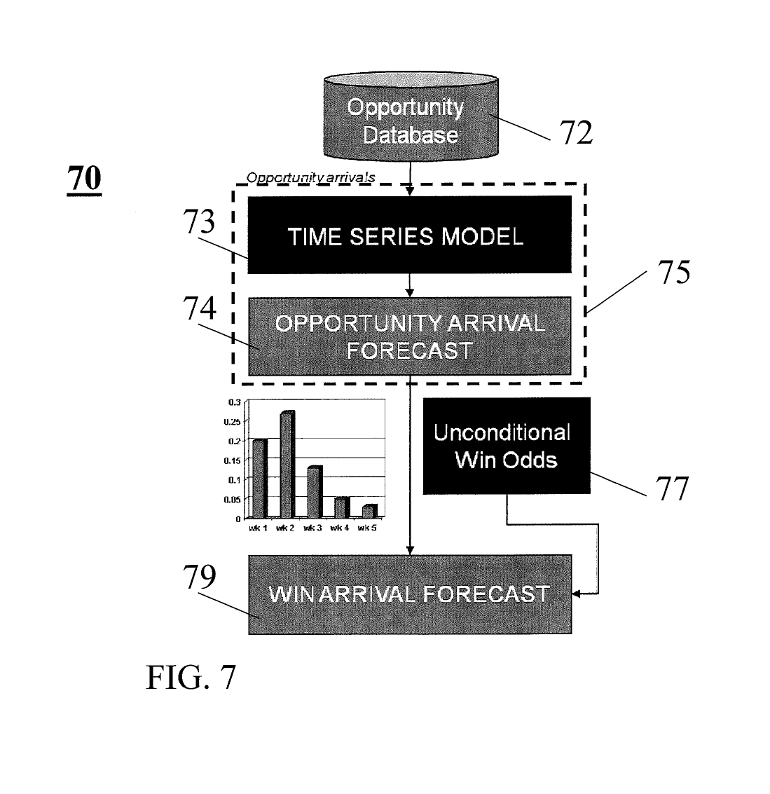

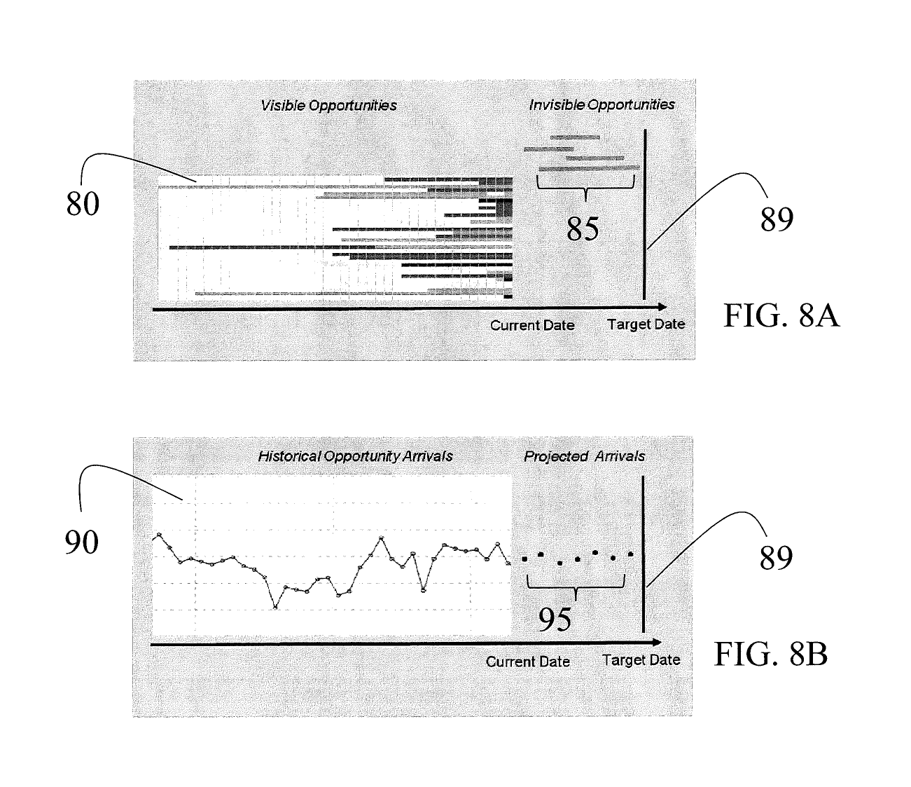

In one embodiment, a method 70 for predicting a number of win arrivals at a future cutoff time (a win arrival forecast 79) for invisible opportunities is shown in FIG. 7. Input data from a database or like memory storage unit 72 includes all the relevant sales stage based 80 (i.e., visible data evolved in the pipeline and having a history) opportunity data. FIG. 8A generally depicts the difference between visible opportunities data 80 and invisible opportunities data 85 i.e., those opportunities 85 that may arrive before the future target date 89, but do not currently exist as shown in FIG. 8A. As shown in FIG. 8A, such visible opportunities data may comprise but is not limited to, the historically relevant SSM data 80 and covariates for each SSM step of visible business opportunities. Such relevant data is accessed by and/or input to a programmed forecasting engine 75. However, in this embodiment of FIG. 7, the system 70 predicts the number of wins in week t based on both the opportunities currently existing (visible opportunities) and invisible opportunities 85. To predict the number of wins from invisible opportunities, the time series pipeline models described herein below are implemented at 73. Opportunity arrival forecasts for predicting wins that arrive in future weeks are shown computed at step 74 and include computations described herein below with respect to equations (18) et seq. For example, the method 70 includes the computing of the number of unconditional win odds 77 using WPD p₀(s,x,c) model as set forth in equation (19) herein below.

From this input data, forecasting engine 75 computes win arrival forecasts 79 in an example future time period, e.g., the next 5 weeks, based on: the SSM sale stage history covariates and computed historical opportunity arrivals using time series models as programmed in the computing system. In one embodiment, FIG. 8B shows the use of historical opportunity arrivals (time series) 90 to project the future arrival times 95 of invisible opportunities (projected arrivals). In one embodiment, forecasting engine also projects future win probabilities based on computed unconditional win odds 77 as shown in FIG. 7 used in the computations of predicting opportunity arrival times 95 as shown in FIG. 8B.

For predicting, the system is configured to denote n_{W}(t) as the number of wins in week t. Given historical opportunity data up to time t, the system predicts n_{W}(t+τ) for τ=1, . . . , τₘₐₓ. The system further denote the predictions as n_{W}(t+τ|t) (τ=1, . . . , τₘₐₓ).

In one embodiment, referred to as an Arrival-Based method, for visible and invisible opportunities, there is denoted the current time t (in a time unit, such as a week). Then, the visible opportunities at time t are defined in the system as the undecided opportunities in the pipeline at time t (data in database). If t+τ denotes the forecasting horizon in the future (τ=1, . . . , τₘₐₓ), then the invisible opportunities are those that arrive in weeks t+1, t+2, . . . , t+τ. There is no history in the pipeline about the invisible opportunities, but they contribute to the total wins and losses in the target week t+τ. The invisible opportunities 85 can be further classified into two types: (i) those that arrive in week t+τ with a terminal status m (win) or m+1 (loss) and (ii) those that arrive in week τ+h for some 1≦h<τ with a transient initial status xε{1, . . . , m−1}.

The method further denotes n_{P}(t+τ|t) as the predicted number of wins in week t+τ from the visible opportunities at time t, and denotes n_{F}(t+t τ|t) as the predicted number of wins in week t+τ from the invisible (future) opportunities arrived at time t+1, . . . , t+τ. Then, the system computes the predicted total number of wins in week t+τ as:

n_{W}(t+τ|t)=n_{P}(t+τ|t)+n_{F}(t+τ|t) (τ=1, . . . , τₘₐₓ). (16)

The following describes embodiments of methods of obtaining n_{P}(t+τ|t) and n_{F}(t+τ|t).

Prediction from Visible Opportunities

To predict the number of wins from visible opportunities (workflows which have up-to-date workflow history), the programmed computing system denotes and defines the following variables and notations:

nₜ: number of visible opportunities at time t

aₜ(u): age of visible opportunity u at time t

xₐ(u): evolution of the SSM stage of visible opportunity u up to age a

zₐ(u): evolution of the covariates of visible opportunity u up to age a

p(τ|a,xₐ,zₐ): probability that a visible opportunity of age a with SSM history xₐ and covariate history zₐ will be won in τ weeks (τ=1, . . . , τₘₐₓ) from the WPD model and computations as described above.

Then, the total number of wins in week t+τ generated by visible opportunities at week t is predicted by the system according to:

$${n}_{P} ( t + τ \vert t ) = {\sum }_{u = 1}^{{n}_{t}} {\sum }_{a = 1}^{∞} I ( {a}_{t} ( u ) = a ) \times p ( τ \vert a , {x}_{a} ( u ) , {z}_{a} ( u ) ) \\ ( τ = 1 , … , {τ}_{m ax} ) , \qquad ( 17 )$$

where I(•) is the indicator function. Note that the win (success) probability distribution p(τ|a,xₐ,zₐ) is obtained from the pipeline models of equations (5) or (9) hereinabove.

Prediction from Invisible Opportunities

The system computes a total number of wins in week t+τ generated from “invisible” opportunities and is configured to define the following variables and notations:

n(t+h,x,c): number of opportunities that arrive in week t+h with initial category c and initial status xε{1, . . . , m, m+1}

n(t+h,x,c|t): prediction of n(t+h,x,c) based on historical data up to time t

p₀(s,x,c): baseline WPD (or unconditional win odds)−probability that an opportunity with initial status xε{1, . . . , m−1} and initial category cε{1, . . . , n} will be won in s weeks (s=1, 2, . . . ) after arrival.

At week t, the system and method is configured to predict the number of wins n_{F} in week t+τ from invisible opportunities as:

$${n}_{F} ( t + τ \vert t ) = {\sum }_{c = 1}^{n} \{ n ( t + τ , m , c \vert t ) + {\sum }_{h = 1}^{τ - 1} {\sum }_{x = 1}^{m - 1} n ( t + h , x , c \vert t ) {p}_{0} ( τ - h , x , c ) \} \\ ( τ = 1 , … , {τ}_{m ax} ) . \qquad ( 18 )$$

From this, the baseline WPD p₀(s,x,c) in (18) is computed as:

p₀(s,x,c)=h₀(s,x,c)×g₀(s,x,c) (s=1,2, . . . ). (19)

There are two ways in which the system computes h₀(s,x,c):

(a) h₀(s,x,c)=h₁(s,1,x,c), where h₁(s,1,x,c) is the DPD given by equations (18)-(19) (geometric model) with a=1 (as defined hereinabove), or
(b) h₀(s,x,c)=h₄(s,1,x,c), where h₄(s,1,x,c) is the DPD given by equation (14) with v=1 (as defined hereinabove).

Moreover, g₀(s,x,c) in (19) is a computed CWP that takes the form of equation (1) (as defined hereinabove) with a=1 without the yₐ term, i,e.,

logit{g₀(s,x,c)}=δ_{c}+ε_{c}s+η_{cx} (x=1, . . . , m−1; c=1, . . . , n; s=1,2, . . . ), (20)

where δ_{c}, ε_{c}, and η_{cx} are the model parameters. These parameters are estimated from historical data by configuring the computing system to apply a logistic regression.

Given the historical arrival data: F(t):={n(1,x,c), . . . , n(t,x,c): x=1, . . . , m; c=1, . . . , n}, the system predicts future arrivals n(t+h,x,c) (h=1, . . . , τₘₐₓ; x=1, . . . , m; c=1, . . . , n) according to

n(t+h,x,c|t)=E{n(t+h,x,c)|F(t)},

where the arrivals n(1,x,c), n(2,x,c) are modeled as random processes such that the conditional distribution of n(t+h,x,c) given historical data F(t) depends solely on a certain parameter vector, where E(•) is the expected value or expectation of the conditional distribution of n(t+h,x,c) given historical data F(t).

For example, configuring the system with a given h and F(t), let the n(t+h,x,c) (x=1, . . . , m; c=1, . . . , n) be independent Poisson random variables with mean

$$λ ( t + h , x , c ) = a ( h , x , c ) + {\sum }_{{x}^{′} = 1}^{m + 1} {\sum }_{{c}^{′} = 1}^{n} \{ {\sum }_{i = 0}^{p} {b}_{i} ( h , x , c ; {x}^{′} , {c}^{′} ) λ ( t - i , {x}^{′} , {c}^{′} ) + {\sum }_{j = 0}^{q} {d}_{j} ( h , x , c ; {x}^{′} , {c}^{′} ) n ( t - j , {x}^{′} , {c}^{′} ) \} , \qquad ( 21 )$$

where a(h,x,c), bᵢ(h,x,c;x′,c′), and dⱼ(h,x,c;x′,c′) are the model parameters that the system estimates from historical data {n(1,x,c), . . . , n(t,x,c)} by the multivariate Poisson autoregression method implemented by the computing system, and p and q are predetermined integers. Under this assumption, the system predicts predicted arrivals by:

n(t+h,x,c|t)=λ(t+h,x,c). (22)

Substituting (21)-(22) in (18) yields the prediction for the number of wins in week t+τ from invisible opportunities.

Alternatively, letting the conditional distribution of log(n(t+h,x,c)) (x=1, . . . , m;c=1, . . . , n) be independent Gaussian with variance σ²(h,x,c) and mean

$$μ ( t + h , x , c ) = a ( h , x , c ) + {\sum }_{{x}^{′} = 1}^{m + 1} {\sum }_{{c}^{′} = 1}^{n} {\sum }_{i = 0}^{p} {b}_{i} ( h , x , c ; {x}^{′} , {c}^{′} ) n ( t - i , {x}^{′} , {c}^{′} ) , \qquad ( 23 )$$

where the parameters a(h,x,c), bᵢ(h,x,c;x′,c′), and σ²(h,x,c) can be estimated from the historical log arrivals {log(n(1,x,c)), . . . , log(n(t,x,c))} by the multivariate autoregression method and p is a predetermined integer. Under this assumption, the predicted arrivals are given by

n(t+h,x,c|t)=exp{μ(t+h,x,c)+½σ²(h,x,c)}. (24)

Substituting (23)-(24) in (18) yields a second way of predicting the number of wins in week t+τ from invisible opportunities.

Residual-Based Model

In a further embodiment, instead of predicting the number of wins from invisible opportunities, the system can predict the residuals from predicting the number of wins in week t+τ based on the visible opportunities at time t, i.e.,

r(t+τ,τ)=n_{P}(t+τ|t)−n_{W}(t+τ) (τ=1, . . . τₘₐₓ).

Configuring the system denote r(t+τ,τ|t) as the prediction of r(t+τ,τ) based on the historical residuals as a time series (Note: the residuals that cannot be forecasted or predicted based on visible opportunities)

R(t)={r(τ+1,τ), . . . , r(t,τ):τ=1, . . . , τₘₐₓ}.

Then, the number of wins n_{W}(t+τ) can be predicted by

n_{W}(t+τ|t)=n_{P}(t+τ|t)−r(t+τ,τ|t) (τ=1, . . . , τₘₐₓ). (25)

The future residuals can be predicted by

r(t+τ,τ|t)=E{r(t+τ,τ)|R(t)},

where the conditional distribution of r(t+τ,τ) is assumed to be independent Gaussian with variance σ²(τ) and mean

$$v ( t + τ , τ ) = a ( τ ) + {\sum }_{i = 0}^{r} {\sum }_{{τ}^{′} = 1}^{{τ}_{m ax}} {b}_{i} ( τ , {τ}^{′} ) r ( t - i , {τ}^{′} ) . \qquad ( 26 )$$

The system and method is configured to estimate parameters a(τ), bᵢ(τ,τ′), and σ²(τ) in (26) from the historical data R(t) by the multivariate autoregression method. Under this assumption, the system and method predicts residual r(t+τ,τ) by the system as

r(t+τ,τ|t)=v(t+τ,τ). (27)

By substituting (26)-(27) and (17) in (25) yields the prediction for the number of wins in week t+τ.

Besides forecasting a win probability of a current opportunity over one or more future target dates using, for example, a sales-stage-based model (e.g., where the work stages are sales stages in a time sequence that leads to closing a sale or not) and age-dependent models, the systems and methods herein may be further configured for: determining the expected decision date of a current opportunity; or determining the expected total revenue or resource needs over a sequence of target dates. It is noted that in computing the following, a company or entity's entire sales stage history may be employed. There may be further incorporated the covariates relating to a sales representative's assessment of win odds, for example, or incorporate client and opportunity profiles. Further, it may be determined the number of expected wins from invisible opportunities using time-series models coupled with models of unconditional win odds.

Prediction of Revenue or Resource Need

In one aspect, the systems and methods herein may be configured to capture predicting the revenue from the opportunities or the amount of resources needed to fulfill the opportunities won at a future time. Letting k(u,t) denote the expected revenue or the expected amount of resources of a certain kind (e.g., hardware, software, manpower, etc.) of the u-th opportunity in the pipeline at time t, then the total revenue or resource need at time t+τ for said opportunities is predicted by

$${K}_{P} ( t + τ \vert t ) = {\sum }_{u = 1}^{n ( t )} k ( u , t ) p ( τ , u , t ) ( τ = 1 , … , {τ}_{m ax} ) \qquad ( 28 )$$

where n(t) denotes the total number of opportunities in the pipeline at time t and p(τ,u,t) denotes the predicted WPD for the u-th opportunity computed by any of the methods described above, e.g., equation (5). Moreover, to account for invisible opportunities, let K(t) denote the actual revenue or resource need at a time t and let e(t,τ)=K_{P}(t|t−τ)−K(t) denote the residual of prediction from known opportunities at time t−τ. Then, similar to equations (26)-(27), one can use time-series models to forecast the future residual e(t+τ,τ)=K_{P}(t+τ|t)−K(t+τ) based on the historical data {e(1+τ,τ), . . . , e(t+τ−1,τ): τ=1, . . . , τₘₐₓ}. With e(t+τ,τ|t) denoting the forecasted residual, the final prediction of the total revenue or resource need is given by

K(t+τ|t)=K_{P}(t+τ|t)−e(t+τ|t) (τ=1, . . . , τₘₐₓ). (29)

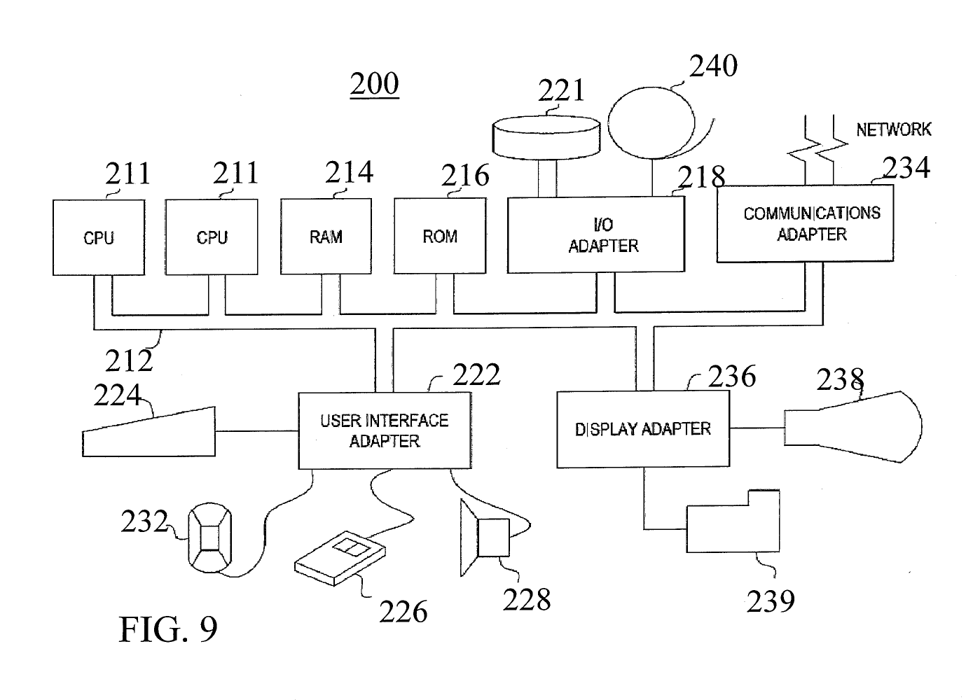

FIG. 9 illustrates an exemplary hardware configuration of a computing system infrastructure 200 in which the present methods of FIGS. 3 and 7 are programmed to run. In one aspect, computing system 200 receives or accesses the historical data from an input database query, and is programmed to perform the predictions in method steps implementing equations (1) and (3)-(5), (2) and (3)-(5), (2) and (8)-(9), (2) and (12)-(13), (2) and (14)-(15), (16)-(24), (25)-(27), (28)-(29). The program may be in Mat-Lab or “R” or any other mathematical modeling software program. The hardware configuration preferably has at least one processor or central processing unit (CPU) 211. The CPUs 211 are interconnected via a system bus 212 to a random access memory (RAM) 214, read-only memory (ROM) 216, input/output (I/O) adapter 218 (for connecting peripheral devices such as disk units 221 and tape drives 240 to the bus 212), user interface adapter 222 (for connecting a keyboard 224, mouse 226, speaker 228, disk drive device 232, and/or other user interface device to the bus 212), a communication adapter 234 for connecting the system 200 to a data processing network, the Internet, an Intranet, a local area network (LAN), etc., and a display adapter 236 for connecting the bus 212 to a display device 238 and/or printer 239 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more tangible computer readable medium(s) having computer readable program code embodied thereon.

Any combination of one or more computer readable medium(s) may be utilized. The tangible computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing. The computer readable medium excludes only a propagating signal.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A computer-implemented system for predicting a probability of an outcome of a workflow comprising:
a storage device for storing data representing a workflow, a workflow comprising two or more work stages and one or more covariables in a time sequence signature, and each work stage having a historical probability of completion as a function of time to complete and having one or more stage states, said stage states including state outcomes of a workflow at completion;
one or more programmed processor units in communication with the storage device for accessing stored data, at least one of said one or more programmed processor units configured to implement a model to:
predict a probability of a completion of a workflow at a future time based on past and current work stages of the workflow, said completion probability predicting using a completion probability distribution (CPD) function;
predict a probability of a workflow success at a time of completion conditional on the time to completion, and the past and current work stages and related covariables, said success probability predicting using a conditional success probability (CSP) function; and
produce a predicted probabilities of success at a sequence of future times by multiplying said predicted CPD with said predicted CSP.

2. The system as in claim 1, wherein the workflow correspond has an up-to-date workflow history at a date of prediction and includes three or more stage states, two of the stage states representing either a successful outcome of a workflow at completion or a failure outcome of a workflow at completion.

3. The system as in claim 1, wherein the processor unit is further configured to generate said CSP function, said CSP function generating comprising:
(a) receiving data representing a time to completion and current values of covariables;
(b) computing data representing parameters of the model;
(c) multiplying one or more of linear and higher order terms formed by said time to completion and said covariables with said model parameters to obtain products;
(d) summing the products obtained from said multiplying;
(e) applying an inverse logit function to said sum from step (d), and
(f) outputting a result from said inverse logit function applying step (e).

4. The system as in claim 1, wherein the processor unit is further configured to generate said completion probability distribution (CPD) function using a Markov chain model, said CPD function generating comprising:
(a) receiving data representing current stage state of a workflow and a target cutoff time
(b) receiving data representing transition probabilities of said Markov chain model, said Markov chain model having states representing said stage states of workflows with a terminal success or failure absorption state;
(c) computing the probability distribution up to said cutoff time of first time absorption of said Markov chain model by multiplying and summing one or more said transition probabilities; and
(d) outputting the computed probability distribution.

5. The system as in claim 1, wherein the processor unit is further configured to generate said completion probability distribution (CPD) function using an age-dependent Markov chain model, said CPD function generating comprising:
(a) receiving data representing a current stage state and an age of a workflow and a target cutoff time, said age representing a time elapsed since a start of the workflow;
(b) receiving data representing transition probabilities of said age-dependent Markov chain model, said age-dependent Markov chain model having states representing the stage states of a workflow with a terminal success or failure absorption state;
(c) computing the probability distribution up to said cutoff time of first time absorption of said age-dependent Markov chain model by multiplying and summing one or more said transition probabilities; and
(d) outputting the computed probability distribution.

6. The system as in claim 1, wherein the processor unit is further configured to generate said completion probability distribution (CPD) function using a semi-Markov chain model, said CPD function generating comprising:
(a) receiving data representing a current stage state of a workflow and a target cutoff time;
(b) receiving data representing transition probabilities and sojourn-time distributions of said semi-Markov chain model having states representing the stage states of a workflow with a terminal success or failure absorption state;
(c) computing the probability distribution up to said target cutoff time of first time absorption of said semi-Markov chain model based on said transition probabilities and sojourn-time distributions; and
(d) outputting the computed probability distribution.

7. The system as in claim 1, wherein the processor unit is further configured to generate said completion probability distribution (CPD) function using an age-dependent semi-Markov chain model, said CPD function generating comprising:
(a) receiving data representing current stage state and age of a workflow and a target cutoff time, said age representing a time elapsed since the start of a workflow;
(b) receiving data representing transition probabilities and sojourn-time distributions of said age-dependent semi-Markov chain model, where states of said Markov chain represent the stage states of a workflow with a terminal success or failure absorption state,
(c) computing the probability distribution up to said cutoff time of first time absorption of said age-dependent semi-Markov chain model based on said transition probabilities and sojourn-time distributions; and
(d) outputting the computed probability distribution.

8. The system as in claim 1, wherein the processor unit is further configured to generate said completion probability distribution (CPD) function using a Kaplan-Meier method comprising:
(a) receiving data representing a current stage state and category and time spent at current stage state of a workflow and a target cutoff time;
(b) receiving data representing time-to-completion probabilities as a three-dimensional array, where the dimensions represent time to completion, stage state, and category;
(c) retrieving from said array the probability distribution up to said cutoff time based on current stage state and category and time spent at current stage state of said workflow; and
(d) outputting the probability distribution obtained.

9. The system as in claim 1, where the predicting a probability of a workflow success at the time of completion is further conditional on one or more covariables, said covariables comprising one or more of:
a covariable representing a workflow owner's assessment of a predicted probability of eventual success of the work in categorical or numerical form;
a covariable representing a workflow owner's assessment of a projected calendar time of completion of the work;
a covariable representing one or more projected properties of an outcome of the workflow at completion; and
a covariable representing a category corresponding to criteria from client and opportunity profiles.

10. A system for predicting an amount of expected successful outcomes for opportunities over a sequence of future time instances comprising:
a storage device for storing workflows data, a workflow comprising two or more work stages and one or more covariables in a time sequence signature, and each work stage having a historical probability of completion as a function of time to complete and having one or more stage states, said stage states including state outcomes of a workflow at completion;
one or more programmed processor units in communication with the storage device for accessing stored data, at least one of said one or more programmed processor units configured to implement a model to:
determine using one or more time-series models, an opportunity arrivals prediction, said opportunity arrivals prediction corresponding to one or more works which arrive at a future time but before a target date of prediction and have no workflow history at the date of prediction;
determine an unconditional win odds model; and
predict an amount of expected successful outcomes for said future opportunities as a product of said determined unconditional win odds and the forecasted opportunity arrivals.

11. The system as in claim 10, wherein said one or more programmed processor units is further configured to:
predict an amount of expected successful outcomes for existing opportunities in the pipeline as a sum of their success probabilities.

12. The system as in claim 10, wherein said one or more programmed processor units is further configured to one of:
predict a total amount of expected successful outcomes by adding predicted amounts of said expected successful outcomes for future opportunities and existing opportunities; or
compute residual predictions obtained by using one or more time-series models and predict a total amount of expected successful outcomes by summing the predicted amounts said expected successful outcomes for existing opportunities and the computed residual predictions obtained by using one or more time-series models.

13. A method for predicting a probability of an outcome of a workflow comprising:
receiving at a computing device, data representing a workflow, a workflow comprising two or more work stages and one or more covariables in a time sequence signature, and each work stage having a historical probability of completion as a function of time to complete and having one or more stage states, said stage states including state outcomes of a workflow at completion;
predicting, using a completion probability distribution (CPD) function, a probability of a completion of a workflow at a future time based on past and current work stages of the workflow;
predicting, using a conditional success probability (CSP) function, a probability of a workflow success at a time of completion conditional on the time to completion, and the past and current work stages and related covariables; and
producing a predicted probabilities of success at a sequence of future times by multiplying said predicted CPD with said predicted CSP,
wherein one or more programmed processor units is configured to implement a model for said probabilities of success predicting.

14. The method as in claim 13, wherein the workflow data includes an up-to-date workflow history at a date of prediction, and includes three or more stage states, two of the stage states representing either a successful outcome of a workflow at completion or a failure outcome of a workflow at completion.

15. The method as in claim 14, further comprising: generating said CSP function, said CSP function generating comprising:
(a) receiving data representing a time to completion and current values of covariables;
(b) computing data representing parameters of the model;
(c) multiplying one or more of linear and higher order terms formed by said time to completion and said covariables with said model parameters to obtain products;
(d) summing the products obtained from said multiplying;
(e) applying an inverse logit function to said sum from step (d), and
(f) outputting a result from said inverse logit function applying step (e).

16. The method as in claim 14, further comprising: generating said completion probability distribution (CPD) function using a Markov chain model, said CPD function generating comprising:
(a) receiving data representing current stage state of a workflow and a target cutoff time
(b) receiving data representing transition probabilities of said Markov chain model, said Markov chain model having states representing said stage states of workflows with a terminal “success” or “failure” absorption state;
(c) computing the probability distribution up to said cutoff time of first time absorption of said Markov chain model by multiplying and summing one or more said transition probabilities; and
(d) outputting the computed probability distribution.

17. The method as in claim 14, further comprising: generating said completion probability distribution (CPD) function using an age-dependent Markov chain model, said CPD function generating comprising:
(a) receiving data representing a current stage state and an age of a workflow and a target cutoff time, said age representing a time elapsed since a start of the workflow;
(b) receiving data representing transition probabilities of said age-dependent Markov chain model, said age-dependent Markov chain model having states representing the stage states of a workflow with a terminal “success” or “failure” absorption state;
(c) computing the probability distribution up to said cutoff time of first time absorption of said age-dependent Markov chain model by multiplying and summing one or more said transition probabilities; and
(d) outputting the computed probability distribution.

18. The method as in claim 14, further comprising: generating said completion probability distribution (CPD) function using a semi-Markov chain model, said CPD function generating comprising:
(a) receiving data representing a current stage state of a workflow and a target cutoff time;
(b) receiving data representing transition probabilities and sojourn-time distributions of said semi-Markov chain model having states representing the stage states of a workflow with a terminal “success” or “failure” absorption state;
(c) computing the probability distribution up to said target cutoff time of first time absorption of said semi-Markov chain model based on said transition probabilities and sojourn-time distributions; and
(d) outputting the computed probability distribution.

19. The method as in claim 14, further comprising: generating said completion probability distribution (CPD) function using an age-dependent semi-Markov chain model, said CPD function generating comprising:
(a) receiving data representing current stage state and age of a workflow and a target cutoff time, said age representing a time elapsed since the start of a workflow;
(b) receiving data representing transition probabilities and sojourn-time distributions of said age-dependent semi-Markov chain model, where states of said Markov chain represent the stage states of a workflow with a terminal “success” and “failure” absorption state,
(c) computing the probability distribution up to said cutoff time of first time absorption of said age-dependent semi-Markov chain model based on said transition probabilities and sojourn-time distributions; and
(d) outputting the computed probability distribution.

20. The method as in claim 14, further comprising: generating said completion probability distribution (CPD) function by:
(a) receiving data representing a current stage state and category and time spent at current stage state of a workflow and a cutoff time;
(b) receiving data representing time-to-completion probabilities as a three-dimensional array, where the dimensions represent time to completion, stage state, and category;
(c) retrieving from said array the probability distribution up to said cutoff time based on current stage state and category and time spent at current stage state of said workflow;
(d) outputting the probability distribution obtained.

21. The method as in claim 14, where the predicting a probability of a workflow success at the time of completion is conditional on one or more covariables, said covariables comprising one or more of:
a covariable representing a workflow owner's assessment of a predicted probability of eventual success of the work in categorical or numerical form;
a covariable representing a workflow owner's assessment of a projected calendar time of completion of the work;
a covariable representing one or more projected properties of an outcome of the workflow at completion; and
a covariable representing a category corresponding to criteria from client and opportunity profiles.

22. A method for predicting an amount of expected successful outcomes for opportunities over a sequence of future time instances comprising:
receiving at a computing device, data representing a workflow, a workflow comprising two or more work stages and one or more covariables in a time sequence signature, and each work stage having a historical probability of completion as a function of time to complete and having one or more stage states, said stage states including state outcomes of a workflow at completion;
determining using one or more time-series models, an opportunity arrivals prediction, said opportunity arrivals prediction corresponding to one or more works which arrive at a future time but before a target date of prediction and have no workflow history at the date of prediction;
determining at said computing device an unconditional win odds model; and
predicting using said computing device an amount of expected successful outcomes for future opportunities as a product of said unconditional win odds and the forecasted opportunity arrivals.

23. The method as in claim 22, further comprising:
predicting using said computing device an amount of expected successful outcomes for existing opportunities in the pipeline as a sum of their success probabilities.

24. The method as in claim 22, further comprising:
predicting a total amount of expected successful outcomes by adding predicted amounts of said expected successful outcomes for future opportunities and existing opportunities; or
computing residual predictions obtained by using one or more time-series models and
predicting a total amount of expected successful outcomes by summing the predicted amounts said expected successful outcomes for existing opportunities and the computed residual predictions obtained by using one or more time-series models.

25. The system of claim 1, wherein the processor unit is further configured to:
predict an expected revenue or an expected amount of a certain type of resource needed at a future time t+τ for a u-th opportunity based on a total number of opportunities currently available at time t, and said produced predicted probabilities of success for the u-th opportunity.

26. The method of claim 13, further comprising:
predicting an expected revenue or an expected amount of a certain type of resource needed at a future time t+τ for a u-th opportunity based on a total number of opportunities currently available at time t, and said produced predicted probabilities of success for the u-th opportunity.
